(19) United States
(12) Patent Application Publication
(10) Pub. No.: US 2026/0342411 A1
(43) Pub. Date: Oct. 29, 2026

(54) METHOD FOR GENERATING A RADIO SIGNAL, AND CORRESPONDING COMPUTER PROGRAM PRODUCTS AND DEVICES

(71) Applicants: UNIVERSITE DE BORDEAUX, BORDEAUX (FR); INSTITUT POLYTECHNIQUE DE BORDEAUX, TALENCE Cedex (FR); CENTRE NATIONAL DE LA RECHERCHE SCIENTIFIQUE, PARIS (FR)

(72) Inventors: François RIVET, TALENCE (FR); Yann DEVAL, BORDEAUX (FR); Hervé LAPUYADE, LEOGNAN (FR); Maxandre FELLMANN, TALENCE (FR)

(21) Appl. No.: 19/471,767

(22) PCT Filed: Apr. 3, 2024
(86) PCT No.: PCT/EP2024/059063

§ 371 Date: Oct. 2, 2025

(30) Foreign Application Priority Data
Apr. 3, 2023 (FR) 2303293

(51) Int. Cl. H04B 7/06; H04B 1/00

(52) U.S. Cl. CPC H04B 7/0682; H04B 1/0078

(57) ABSTRACT

A method for generating a radio signal intended to be transmitted over a transmission channel via the frequency translation of a first intermediate frequency signal and of a second intermediate frequency signal. Such a method includes: a frequency translation step translating a baseband signal, producing an intermediate frequency channel signal, and a generation step generating a phase-shifted channel signal according to the intermediate frequency channel signal. Such a generation step includes a step of Hilbert filtering, translated in the Walsh domain, filtering the channel signal transformed via a Walsh transform. The first intermediate frequency signal is linearly dependent on the intermediate frequency channel signal. The second intermediate frequency signal is linearly dependent on the phase-shifted channel signal.

### CROSS REFERENCE TO RELATED APPLICATIONS

This application is a National Stage of International Application No. PCT/EP2024/059063, having an International Filing Date of 3 Apr. 2024, which designated the United States of America, and which International Application was published under PCT Article 21(2) as WO Publication No. 2024/208899 which claims priority from and the benefit of French Patent Application No. 2303293 filed on 3 Apr. 2023, the disclosures of which are incorporated herein by reference in their entireties.

### BACKGROUND

### Field

The field of the disclosure is that of data transmission through the use of a radio signal.

The disclosure relates more particularly to a method for generating a radio signal intended to be transmitted over a transmission channel (or over two transmission channels).

Thus, the disclosure has applications, in particular, yet not exclusively, in the field of mobile telephony (for example 4G or 5G networks as defined by 3GPP (3 rd Generation Partnership Project)), WLANs (Wireless Local Area Network, for example using the WiFi), digital broadcasting systems (DVB-T or Digital Video Broadcasting-Terrestrial, ISDB-T or Integrated Services Digital Broadcasting-Terrestrial, DAB or Digital Audio Broadcasting), high-speed wireless Internet access (WiMAX), asymmetric digital links (xDSL), or point-to-point links, etc.

### Brief Description of Related Developments

A radio frequency (RF) transmitter architecture comprises several key elements in order to transmit information. For example, the modulating signal representative of the information to be transmitted is conventionally generated digitally, in baseband or directly in an intermediate frequency (IF) using a microprocessor and converted into an analog signal using digital-to-analog converters, (DAC). A mixer is used to translate the frequencies of this signal, from the baseband or from the intermediate frequency, to an RF frequency. A power amplifier increases the signal strength and the antenna radiates an electromagnetic field image of the signal generated by the transmitter considered.

Among the known transmitter architectures, the image rejection architecture makes it possible to suppress the image channel generated during frequency translation from an intermediate frequency to RF, as described for example in the work by B. Razavi, “Rf Microelectronics”, Prentice Hall, 1998.

[FIG. 1] presents such an architecture. More particularly, the transmitter 100 uses the IQ (in-phase/quadrature) signal concept to eliminate the image channel during frequency translation from an intermediate frequency to a RF transmission channel. In the present case, the transmitter 100 comprises:
a digital quadrature mixer 110 producing an intermediate frequency channel signal x_{IF}[n] from digital modulating baseband signals, x_{BB,I}[n] and x_{BB,Q}[n], for channels I and Q respectively. The intermediate frequency channel signal is centered on the intermediate frequency f_{IF};
a DAC 140 producing the analog intermediate frequency channel signal x_{IF}(t) from the digital signal x_{IF}[n];
an analog Hilbert filter 130, with impulse response g(t), producing a phase-shifted channel signal x_{IF,D}(t) according to the analog intermediate frequency channel signal x_{IF}(t); and
an analog quadrature mixer 120 producing the radio signal x_{RF}(t) intended to be transmitted over the transmission channel from a first intermediate frequency signal x_{IF,1}(t) and from a second intermediate frequency signal x_{IF,2}(t). More particularly, the first intermediate frequency signal x_{IF,1}(t) is, in the present case, equal to the analog intermediate frequency channel signal x_{IF}(t). The second intermediate frequency signal x_{IF,2}(t) is, in this case, equal to the phase-shifted channel signal x_{IF,D}(t).

The analog quadrature mixer 120 is fed by two quadrature local oscillator signals. The two local oscillator signals have a radio frequency component f_{RF}. Thus, as illustrated in [FIG. 1], the transmission channel is in this case centered on a frequency equal to the radio frequency f_{RF} plus the intermediate frequency f_{IF}. As described below with reference to [FIG. 1b], it is also possible to translate the signal to be transmitted over the channel centered on the image frequency equal to the radio frequency f_{RF} minus the intermediate frequency f_{IF} by adapting on the sign of the intermediate frequency signals to undergo frequency translation.

Referring back to [FIG. 1], according to the implementations considered, the analog Hilbert filter 130 is implemented, for example thanks to an RC-CR network or a polyphase filter. However, the phase shift sought is only obtained over a narrow frequency band. It is therefore not possible to use this architecture for broadband signals. Similarly, such an architecture is made difficult to reconfigure so as to be able to generate signals over distant carriers in the frequency domain. To overcome this problem, Hilbert filtering can be implemented in the digital domain as illustrated in [FIG. 1a].

Furthermore, in a manner known per se, by adapting the sign of the first intermediate frequency signal x_{IF,1}(t) or of the second intermediate frequency signal x_{IF,2}(t), a choice can be made to translate the signal to be transmitted over the channel centered on a frequency equal to the radio frequencies f_{RF} plus the intermediate frequency f_{IF}, or over the channel centered on the image frequency equal to the radio frequencies f_{RF} minus the intermediate frequency f_{IF}. [FIG. 1b] illustrates this effect in the case where the impulse response, −g[n], of the Hilbert filter 130 is the opposite of that of the Hilbert filter 130 of [FIG. 1a]. As the other elements of [FIG. 1b] are configured identically to those of [FIG. 1a], it is observed that:
the radio signal x_{RF}(t) generated by the transmitter 100 of [FIG. 1a] is located in the transmission channel centered on the frequency equal to the radio frequency f_{RF} plus the intermediate frequency f_{IF};
the radio signal x_{RF}(t) generated by the transmitter 100 of [FIG. 1b] is located in the image transmission channel centered on the image frequency equal to the radio frequency f_{RF} minus the intermediate frequency f_{IF}.

Such an effect (i.e. the translation of the radio signal x_{RF}(t) in the transmission channel or in the image transmission channel) is also obtained regardless of the intermediate frequency signal (x_{IF,1}(t) or X_{IF,2}(f)) to which the minus sign is applied, and regardless of the location of the data path where the minus sign in question is applied.

However, even though the implementation of Hilbert filtering in the digital domain makes it possible to overcome the bandwidth limitation problems described above with reference to [FIG. 1], such digital filtering requires significant resources in terms of computing power.

There is therefore a need for a technique for generating a radio signal based on an image rejection architecture that has a wide bandwidth as well as a limited cost in terms of computing power.

### SUMMARY

One aspect of the disclosure proposes a method for generating a radio signal intended to be transmitted over a first transmission channel. According to such a method, a transmitter carries out: a frequency translation by implementing a quadrature mixer producing the radio signal from a first intermediate frequency signal and a second intermediate frequency signal.

For the first transmission channel, the transmitter:
carries out a frequency translation of first baseband signals producing a first intermediate frequency channel signal; and
generates a first phase-shifted channel signal according to the first intermediate frequency channel signal.

The first intermediate frequency signal is linearly dependent on the first intermediate frequency channel signal. The second intermediate frequency signal is linearly dependent on the first phase-shifted channel signal. The generation of the first phase-shifted channel signal comprises:
a Walsh transform of the first intermediate frequency channel signal, producing a first transformed channel signal;
Hilbert filtering, translated to the Walsh domain, of the first transformed channel signal, producing a first filtered, transformed channel signal; and
an inverse Walsh transform of the first filtered, transformed channel signal, producing the first phase-shifted channel signal.

Thus, the disclosure proposes a novel and inventive solution for generating a radio signal based on an image rejection architecture. More particularly, the implementation of Hilbert filtering in the Walsh domain reduces the computing power required to implement such a filter. Furthermore, the implementation of this filter in the digital domain allows a wide operating bandwidth to be obtained.

In some aspects, the quadrature mixer is fed by two quadrature local oscillator signals. The two local oscillator signals have a radio frequency component. The first channel is centered on a frequency equal to the radio frequency plus the intermediate frequency or on a frequency equal to the radio frequency minus the intermediate frequency.

In some aspects, the radio signal is also intended to be transmitted over a second transmission channel. For the second transmission channel, the transmitter:
carries out a frequency translation of second baseband signals producing a second intermediate frequency channel signal; and
generates a second phase-shifted channel signal according to the second intermediate frequency channel signal.

The first intermediate frequency signal is linearly dependent on a sum of the first intermediate frequency channel signal and of the second intermediate frequency channel signal. The second intermediate frequency signal is linearly dependent on a difference between the first phase-shifted channel signal and the second phase-shifted channel signal. The generation of the second phase-shifted channel signal comprises:
a Walsh transform of the second intermediate frequency channel signal, producing a second transformed channel signal;
Hilbert filtering, translated to the Walsh domain, of the second transformed channel signal, producing a second filtered, transformed channel signal; and
an inverse Walsh transform of the second filtered, transformed channel signal, producing the second phase-shifted channel signal.

In some aspects, the radio signal is also intended to be transmitted over a second transmission channel. For the second transmission channel, the transmitter:
carries out a frequency translation of second baseband signals producing a second intermediate frequency channel signal; and
generates a second phase-shifted channel signal according to the second intermediate frequency channel signal.

The first intermediate frequency signal is linearly dependent on a difference between the first intermediate frequency channel signal and the second intermediate frequency channel signal. The second intermediate frequency signal is linearly dependent on a sum of the first phase-shifted channel signal and of the second phase-shifted channel signal. The generation of the second phase-shifted channel signal comprises:
a Walsh transform of the second intermediate frequency channel signal, producing a second transformed channel signal;
Hilbert filtering, translated to the Walsh domain, of the second transformed channel signal, producing a second filtered, transformed channel signal; and
an inverse Walsh transform of the second filtered, transformed channel signal, producing the second phase-shifted channel signal.

Thus, two channels capable of conveying different data are generated in a single step of frequency translation to radio frequencies.

In some aspects, the quadrature mixer is fed by two quadrature local oscillator signals, the two local oscillator signals having a radio frequency component. The first channel is centered on a frequency equal to the radio frequency plus the intermediate frequency. The second channel is centered on a frequency equal to the radio frequency minus the intermediate frequency.

In some aspects, Hilbert filtering comprises block digital filtering.

In some aspects, the Walsh transform and the inverse Walsh transform are discrete Walsh transforms. The Walsh sequences implemented in said transforms are ordered according to a Hadamard order.

Thus, the computing power required to implement the Walsh transforms and/or Hilbert filtering is further reduced.

The disclosure further relates to a computer program comprising program code instructions for implementing a generation method as described above, according to any one of its various aspects, when it is executed on a computer.

One aspect of the disclosure proposes a transmitter for generating a radio signal intended to be transmitted over a first transmission channel. Such a transmitter comprises means configured to implement the steps of the generation method according to the disclosure (according to any one of the aforementioned various aspects). Thus, the features and advantages of this transmitter are the same as those of the corresponding steps of the generation method described hereinabove. Consequently, they are not described in any further detail.

### BRIEF DESCRIPTION OF THE FIGURES

Other aims, features and advantages of the disclosure will appear more clearly upon reading the following description, which is given by way of a simple illustrative and non-limiting example, with reference to the figures, wherein:

FIG. 1, discussed above in the section entitled “Prior art and its drawbacks”, shows an image rejection radio frequency transmitter according to a known technique;

FIG. 1a, discussed above in the section entitled “Prior art and its drawbacks”, shows an image rejection radio frequency transmitter according to another known technique;

FIG. 1b, discussed above in the section entitled “Prior art and its drawbacks”, shows the effect of a sign change in the impulse response of the Hilbert filter implemented in the radio frequency transmitter of FIG. 1a;

FIG. 2 illustrates an image rejection radio frequency transmitter according to one aspect of the disclosure;

FIG. 3 illustrates an image rejection radio frequency transmitter according to another aspect of the disclosure;

FIG. 4 shows the steps of a method for generating a radio signal according to one aspect of the disclosure;

FIG. 5 shows an example of a device structure enabling the implementation of some steps of the method for generating a radio signal of FIG. 4 according to one aspect of the disclosure.

### DETAILED DESCRIPTION

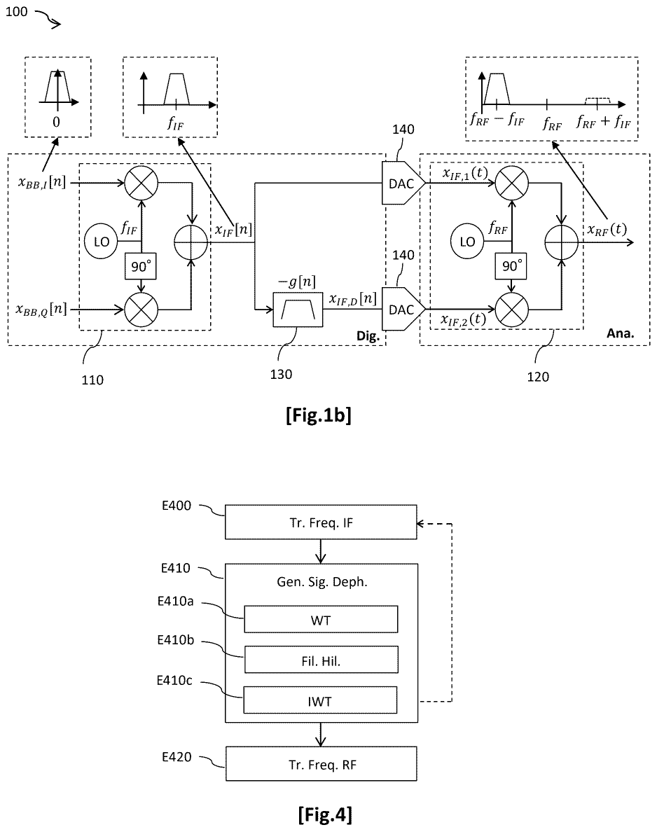

An image rejection radio frequency transmitter 200 according to one aspect of the disclosure will now be described with reference to [FIG. 2].

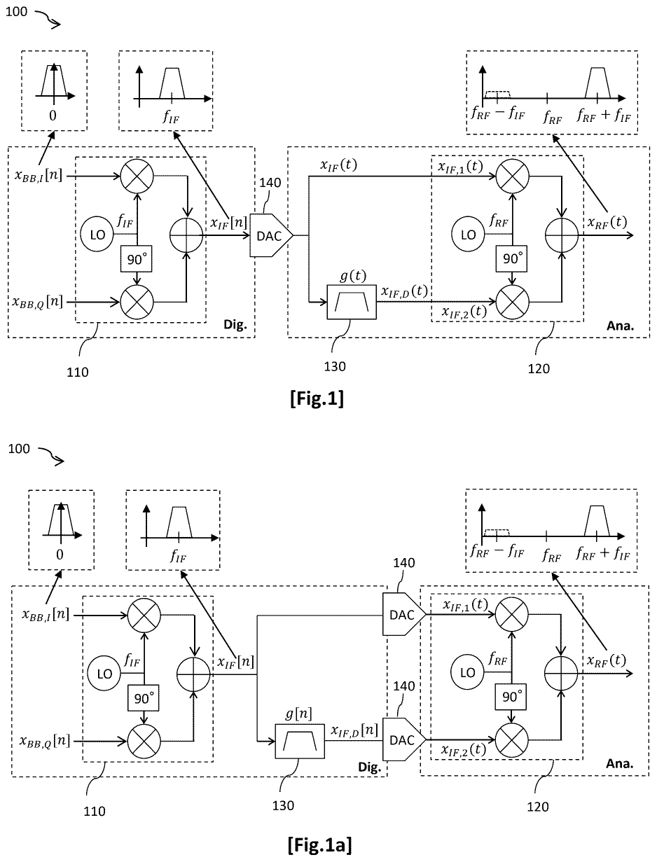

With respect to the known architecture presented above with reference to [FIG. 1b], the transmitter 200 comprises a digital block 210 comprising:
a Walsh transform block 220 transforming the intermediate frequency channel signal x_{IF}[n], producing a transformed channel signal X_{IF}; and
a Hilbert filtering block 230, translated in the Walsh domain, filtering the transformed channel signal X_{IF}, producing a filtered, transformed channel signal X_{IF,D}.

Hilbert filtering is implemented here in the form of block digital filtering, i.e. by taking an input sample block and producing an output sample block. More particularly, the output sample block put in a vector form X_{IF,D} is a function of a matrix product between a filtering matrix G_{w} and the input sample block put in a vector form, X_{IF}. The filtering matrix G_{w} is a function of the impulse response, g[n], of the Hilbert filter implemented in the block 230, as described for example in the article by C. Zarowski and M. Yunik, “Spectral filtering using the fast walsh transform”, IEEE Transactions on Acoustics, Speech, and Signal Processing, vol. 33, no. 5, pp. 1246-1252, 1985. According to certain implementations, the Walsh transform implements Walsh sequences ordered according to a Hadamard order as described, for example, in the article by J. Johnson and M. Puschel, “In search of the optimal walsh-hadamard transform,” in 2000 IEEE International Conference on Acoustics, Speech, and Signal Processing. Proceedings (Cat. No.00CH37100), vol. 6, 2000, pp. 3347-3350 vol. 6. Thus, the filtering matrix G_{w} is block-diagonal and antisymmetric, thereby reducing the computing power required for Hilbert filtering.

However, in other aspects, Hilbert filtering, translated to the Walsh domain, is implemented in other forms, for example in the form of a FIR (“Finite Impulse Response”) or IIR (“Infinite Impulse Response”) filter.

Referring back to [FIG. 2], the transmitter 200 further comprises a block 240 for the inverse Walsh transform of the filtered, transformed channel signal X_{IF,D}, producing the phase-shifted channel signal in the analog domain. More particularly, the phase-shifted channel signal is, in this case, equal to the second intermediate frequency signal x_{IF,2}(t).

Moreover, according to the first embodiment, the first intermediate frequency signal x_{IF,1}(t) is, in the present case, equal to the analog intermediate frequency channel signal x_{IF}(t).

However, depending on the hardware implementation considered (for example due to the presence of amplifiers on the data path), the first intermediate frequency signal x_{IF,1}(t) is typically proportional to the first intermediate frequency channel signal x_{IF}(t). Similarly, the second intermediate frequency signal x_{IF,2}(t) is typically proportional to the first phase-shifted channel signal x_{IF,D}(t). Preferably, the proportionality coefficient is substantially the same for the generation of the first intermediate frequency signal x_{IF,1}(t) and for the generation of the second intermediate frequency signal x_{IF,2}(t), the first intermediate frequency channel signal x_{IF}(t) and the first phase-shifted channel signal, x_{IF,D}(t) being conventionally generated with the same power (or energy) and time-synchronous. Thus, the first intermediate frequency signal x_{IF,1}(t) and the second intermediate frequency signal x_{IF,2}(t) have substantially equal power (or energy). This results in optimal image rejection. However, according to the hardware implementations considered, the existence of mismatches between the proportionality coefficients can lead to an imperfect rejection of the image channel during recombination of the signals.

Referring back to [FIG. 2], the implementation of Hilbert filtering in the Walsh domain reduces the computing power required to implement such a filter. Furthermore, the implementation of this filter in the digital domain allows a wide operating bandwidth to be obtained.

Furthermore, as described above with reference to the prior art, following the sign of the impulse response, g[n], and therefore of the filtering matrix G_{w} of the Hilbert filter implemented in the block 230, the radio signal x_{RF}(t) generated by the transmitter 200 is located in the transmission channel centered on the frequency equal to the radio frequency f_{RF} plus the intermediate frequency f_{IF} or in the transmission channel centered on the image frequency equal to the radio frequency f_{RF} minus the intermediate frequency f_{IF} (the case where the radio frequency f_{RF} is higher than the intermediate frequency f_{IF}). Such an effect (i.e. the translation of the radio signal x_{RF}(t) in the transmission channel considered or in the image transmission channel centered on the image frequency) is also obtained regardless of the intermediate frequency signal (x_{IF,1}(t) or x_{IF,2}(t)) to which the minus sign is applied, and regardless of the location of the corresponding data path where the minus sign in question is applied.

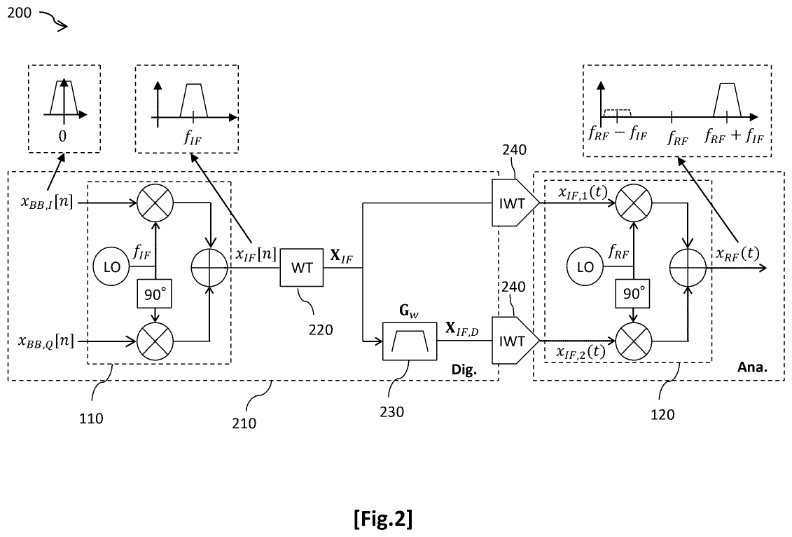

An image rejection radio frequency transmitter 200 according to another aspect of the disclosure will now be described with reference to [FIG. 3].

With respect to the aspect presented above with reference to [FIG. 2], the transmitter 200 according to the present aspect comprises two digital blocks 210 as described above. More particularly:
a first digital block 210 produces, for a first transmission channel, a first transformed channel signal X_{IF} and a first filtered, transformed channel signal X_{IF,D}; and
a second digital block 210 produces, for a second transmission channel (i.e. the transmission channel centered on the image frequency of the frequency on which the first transmission channel is centered), a second transformed channel signal X_{I,IF} and a second filtered, transformed channel signal X_{I,I,F,D}.

Furthermore, a first summer 250 followed by an inverse Walsh transform block 240 produces a first intermediate frequency signal x_{IF,1}(t) linearly dependent on a sum of the first intermediate frequency channel signal x_{IF}(t) and of the second intermediate frequency channel signal X_{I,IF}(t).

Similarly, a second summer 250 followed by an inverse Walsh transform block 240 produces a second intermediate frequency signal x_{IF,2}(t) linearly dependent on a difference between the first phase-shifted channel signal x_{IF,D}(t) and the second phase-shifted channel signal x_{I,IF,D}(t).

For example, according to the hardware implementation considered (for example due to the presence of amplifiers on the data path), the first intermediate frequency signal x_{IF,1}(t) is typically proportional to the sum of the first intermediate frequency channel signal x_{IF}(t) and of the second intermediate frequency channel signal x_{I,IF}(t). Similarly, the second intermediate frequency signal x_{IF,2}(t) is typically proportional to a difference between the first phase-shifted channel signal x_{IF,D}(t) and the second phase-shifted channel signal x_{I,IF,D}(t). As discussed above with reference to [FIG. 2], the proportionality coefficient is preferably substantially the same for the generation of the first intermediate frequency signal x_{IF,1}(t) and for the generation of the second intermediate frequency signal x_{IF,2}(t). The first intermediate frequency channel signal x_{IF}(t), the first phase-shifted channel signal x_{IF,D}(t), the second intermediate frequency channel signal x_{I,IF}(t), as well as the second phase-shifted channel signal x_{I,IF,D}(t) are indeed conventionally generated with the same power (or the same energy) and are time-synchronous. Thus, the first intermediate frequency signal x_{IF,1}(t) and the second intermediate frequency signal x_{IF,2}(t) have substantially equal power (or energy). Thus, optimal image rejection, and therefore decorrelation between the signals present in the first and second transmission channels, is obtained. However, according to the hardware implementations considered, mismatches between the proportionality coefficients can lead to an imperfect rejection of the image channel during recombination of the signals and therefore to “cross-talk” between the signals present in the first transmission channel and the second transmission channel.

Referring back to [FIG. 3], the impulse response, g[n], and therefore the filtering matrix G_{w} of the Hilbert filter implemented in the block 230 of the first digital block 210, as well as the impulse response, g[n], and therefore the filtering matrix G_{w} of the Hilbert filter implemented in the block 230 of the second digital block 210, have the same sign. Thus, the radio signal x_{RF}(t) generated by the transmitter 200 has:
a first frequency component corresponding to the first transmission channel centered on the frequency equal to the radio frequency f_{RF} plus the intermediate frequency f_{IF}; and
a second frequency component corresponding to the second transmission channel centered on the image frequency equal to the radio frequency f_{RF} minus the intermediate frequency f_{IF}.

In other words, the radio signal x_{RF}(t) generated by the transmitter 200 is intended to be transmitted over a first transmission channel centered on the frequency equal to the radio frequency f_{RF} plus the intermediate frequency f_{IF}, and over a second transmission channel centered on the image frequency equal to the radio frequency f_{RF} minus the intermediate frequency f_{IF}.

However, in a general manner and as described above with reference to [FIG. 2], the first transmission channel is centered on the frequency equal to the radio frequency f_{RF} plus the intermediate frequency f_{IF}, or centered on the image frequency equal to the radio frequency f_{RF} minus the intermediate frequency f_{IF} depending on whether or not the minus sign is applied on the data path producing the first intermediate frequency channel signal X_{IF}(t) (respectively the first phase-shifted channel signal x_{IF,D}(t)) ultimately composing the first intermediate frequency signal x_{IF,1}(t) (respectively the second intermediate frequency signal x_{IF,2}(t)). Moreover, such an effect is also obtained regardless of the location of the data path where the minus sign in question is applied.

Likewise, the second transmission channel is centered on the frequency equal to the radio frequency f_{RF} plus the intermediate frequency f_{IF} or centered on the image frequency equal to the radio frequency f_{RF} minus the intermediate frequency f_{IF} depending on whether the minus sign is applied on the data path producing the second intermediate frequency channel signal x_{I,IF}(t) (respectively on the data path producing the second phase-shifted channel signal x_{I,IF,D}(t)) ultimately composing the first intermediate frequency signal x_{IF,1}(t) (respectively the second intermediate frequency signal x_{IF,2}(t)). Moreover, such an effect is also obtained regardless of the location of the data path where the minus sign in question is applied.

Thus, in order to transmit the radio signal x_{RF}(t) over the two channels centered on the frequency equal to the radio frequency f_{RF} plus the intermediate frequency f_{IF}, and on the image frequency equal to the radio frequency f_{RF} minus the intermediate frequency f_{IF}, alternatively to the case illustrated in [FIG. 3], the following may be provided:
the first summer 250 followed by the inverse Walsh transform block 240 producing a first intermediate frequency signal x_{IF,1}(t) linearly dependent on a difference between the first intermediate frequency channel signal x_{IF}(t) and the second intermediate frequency channel signal x_{I,IF}(t); and
the second summer 250 followed by the inverse Walsh transform block 240 producing a second intermediate frequency signal x_{IF,2}(t) linearly dependent on a sum of the first phase-shifted channel signal x_{IF,D}(t) and of the second phase-shifted channel signal x_{I,IF,D}(t).

Again, the minus sign on the data path producing the second phase-shifted channel signal can be applied either on the filtering matrix G_{w} (or the impulse response g[n]) of the Hilbert filter implemented in the block 230 or at another location of the data path corresponding to the signal filtered by the Hilbert filter in question.

For example, the first intermediate frequency signal x_{IF,1}(t) is proportional to the difference between the first intermediate frequency channel signal x_{IF}(t) and the second intermediate frequency channel signal x_{I,IF}(t). Similarly, the second intermediate frequency signal x_{IF,2}(t) is proportional to the sum of the first phase-shifted channel signal x_{IF,D}(t) and of the second phase-shifted channel signal x_{I,IF,D}(t). As discussed above, the proportionality coefficient is preferably substantially the same for the generation of the first intermediate frequency signal x_{IF,1}(t) and for the generation of the second intermediate frequency signal x_{IF,2}(t). The first intermediate frequency channel signal x_{IF}(t), the first phase-shifted channel signal x_{IF,D}(t), the second intermediate frequency channel signal x_{I,IF}(t), as well as the second phase-shifted channel signal x_{I,IF,D}(t) are indeed conventionally generated with the same power (or the same energy) and are time-synchronous. Thus, the first intermediate frequency signal x_{IF,1}(t) and the second intermediate frequency signal x_{IF,2}(t) have substantially equal power (or energy).

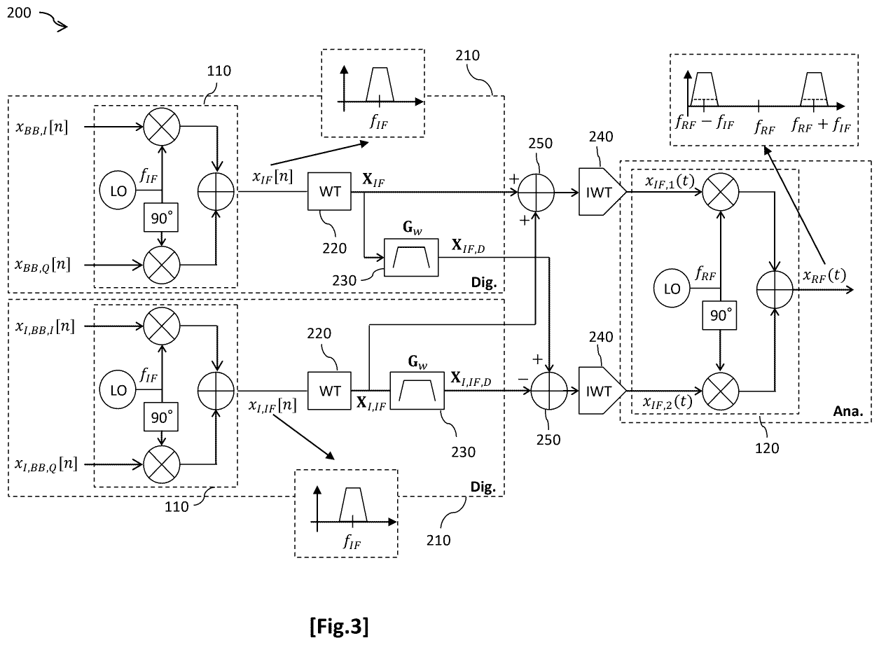

The steps of a method for generating a radio signal x_{RF}(t) according to one aspect of the disclosure will now be described with reference to [FIG. 4].

More particularly, the radio signal x_{RF}(t) is intended to be transmitted over a first transmission channel.

Thus, during a step E400, a transmitter 200 (for example the transmitter 200 of [FIG. 2] or the transmitter 200 of [FIG. 3]) carries out, for the first transmission channel, a frequency translation of first baseband signals x_{BB,I}[n] and X_{BB,Q}[n] for the channels I and Q respectively, producing a first intermediate frequency channel signal x_{IF}[n].

During a step E410, the transmitter 200 generates, for the first transmission channel, a first phase-shifted channel signal according to the first intermediate frequency channel signal x_{IF}[n].

More particularly, step E410 comprises:
a Walsh transform step E410a transforming the first intermediate frequency channel signal x_{IF}[n], producing a first transformed channel signal X_{IF};
a Hilbert filtering step E410b, translated in the Walsh domain, filtering the first transformed channel signal X_{IF}, producing a first filtered, transformed channel signal X_{IF,D};
an inverse Walsh transform step E410c, transforming the first filtered, transformed channel signal X_{IF,D}, producing the first phase-shifted channel signal.

During a step E420, the transmitter 200 carries out, for the first transmission channel, a frequency translation by implementing a quadrature mixer 120 producing the radio signal x_{RF}(t) from a first intermediate frequency signal x_{IF,1}(t) and a second intermediate frequency signal x_{IF,2}(t).

More particularly, the first intermediate frequency signal x_{IF,1}(t) is linearly dependent on the first intermediate frequency channel signal x_{IF}[n]. The second intermediate frequency signal x_{IF,2}(t) is linearly dependent on the first phase-shifted channel signal.

For example, as discussed above with reference to [FIG. 2], the first intermediate frequency signal x_{IF,1}(t) is proportional to the first intermediate frequency channel signal x_{IF}(t) and the second intermediate frequency signal x_{IF,2}(t) is proportional to the first phase shifted channel signal x_{IF,D}(t). Preferably, the proportionality coefficient is preferably substantially the same for the generation of the first intermediate frequency signal x_{IF,1}(t) and for the generation of the second intermediate frequency signal x_{IF,2}(t).

According to the implementations, the quadrature mixer 120 is fed by two quadrature local oscillator signals. The two local oscillator signals have a radio frequency component f_{RF}. The first channel is centered on a frequency equal to:
the radio frequency f_{RF} plus the intermediate frequency f_{IF}; or
the radio frequency f_{RF} minus the intermediate frequency f_{IF}.

As described above, for example with reference to [FIG. 2] or [FIG. 3], the translation of the radio signal x_{RF}(t) in a transmission channel or in the image transmission channel is obtained by applying a minus sign to the intermediate frequency signal (x_{IF,1}(t) or x_{IF,2}(t)). This is obtained regardless of where in the data path the minus sign in question is applied.

In some aspects, the radio signal x_{RF}(t) is also intended to be transmitted over a second transmission channel. Thus, during step E400, the transmitter 200 (for example the transmitter 200 of [FIG. 3]) furthermore carries out, for the second transmission channel, a frequency translation of second baseband signals x_{I,BB,I}[n] and x_{I,BB,Q}[n] for the channels I and Q respectively, producing a second intermediate frequency channel signal x_{I,IF}[n].

During step E410, the transmitter 200 generates, for the second transmission channel, a second phase-shifted channel signal according to the second intermediate frequency channel signal x_{I,IF}[n].

More particularly, during step E410:
the Walsh transform step E410a transforming the second intermediate frequency channel signal x_{I,IF}[n] produces a second transformed channel signal x_{I,IF};
the Hilbert filtering step E410b, translated in the Walsh domain, filtering the second transformed channel signal X_{I,IF}, produces a second filtered, transformed channel signal X_{I,IF,D};
the inverse Walsh transform step E410c, transforming the second filtered, transformed channel signal X_{I,IF,D}, produces the second phase-shifted channel signal.

The first intermediate frequency signal x_{IF,1}(t) is linearly dependent on a sum of the first intermediate frequency channel signal x_{IF}[n] and of the second intermediate frequency channel signal x_{I,IF}[n]. The second intermediate frequency signal x_{IF,2}(t) is linearly dependent on a difference between the first phase-shifted channel signal and the second phase-shifted channel signal. These are the operations corresponding to the case illustrated in [FIG. 3]. However, as discussed above with reference to [FIG. 3], the same effect is obtained when, alternatively, the first intermediate frequency signal x_{IF,1}(t) is linearly dependent on a difference between the first intermediate frequency channel signal x_{IF}[n] and the second intermediate frequency channel signal x_{I,IF}[n]. The second intermediate frequency signal x_{IF,2}(t) is linearly dependent on a sum of the first phase-shifted channel signal and of the second phase-shifted channel signal.

For example, as discussed above with reference to [FIG. 3], the first intermediate frequency signal x_{IF,1}(t) is proportional to the sum of the first intermediate frequency channel signal x_{IF}(t) and of the second intermediate frequency channel signal x_{I,IF}(t). The second intermediate frequency signal x_{IF,2}(t) is proportional to a difference between the first phase-shifted channel signal x_{IF,D}(t) and the second phase-shifted channel signal x_{I,IF,D}(t). Preferably, the proportionality coefficient is substantially the same for the generation of the first intermediate frequency signal x_{IF,1}(t) and for the generation of the second intermediate frequency signal x_{IF,2}(t).

Thus, two channels capable of conveying different data are generated in a single step of frequency translation to radio frequencies.

More particularly, the quadrature mixer 120 is fed by two quadrature local oscillator signals. The two local oscillator signals have a radio frequency component f_{RF}. Thus:
the first channel is centered on a frequency equal to the radio frequency f_{RF} plus the intermediate frequency f_{IF}; and
the second channel is centered on a frequency equal to the radio frequency f_{RF} minus the intermediate frequency f_{IF}.

In some aspects, Hilbert filtering is implemented in the form of block digital filtering as described above with reference to [FIG. 2]. According to some implementations, the Walsh transform implements Walsh sequences ordered according to a Hadamard order. Thus, the filtering matrix is block-diagonal and antisymmetric, thereby reducing the computing power required for Hilbert filtering.

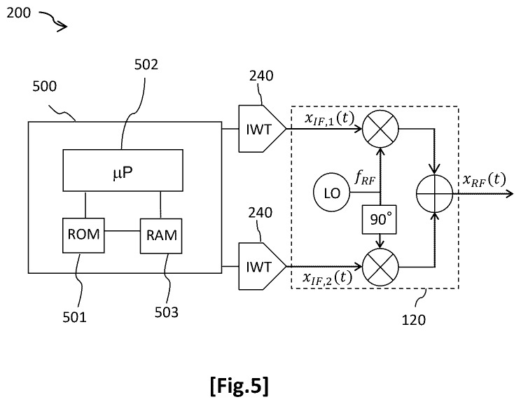

An example of a structure of the transmitter 200 comprising means that allow all or part of the steps of the generation method of [FIG. 4] according to one aspect of the disclosure to be implemented, will now be described with reference to [FIG. 5].

More particularly, the transmitter 200 comprises and electronic device 500 comprising various means such as a random-access memory 503 (for example a RAM memory), and a processing unit 502 equipped for example with a processor, and controlled by a computer program stored in a read-only memory 501 (for example a ROM memory or a hard disk). On initialization, the code instructions of the computer program are for example loaded into the random-access memory 503 before being executed by the processor of the processing unit 502.

The electronic device 500 is more particularly configured to carry out the steps of the generation method of [FIG. 4] (according to any one of the aspects and/or alternative aspects described above with reference to [FIG. 4]) implemented by the digital blocks 210 described above with reference to [FIG. 2] and [FIG. 3], i.e. the steps E400, E410a and E410b.

This [FIG. 5] illustrates only a particular manner, among several possible ones, for producing the electronic device 500 so that it carries out all or some of the aforementioned steps of the generation method of [FIG. 4] (according to any one of the aspects and/or alternative aspects described hereinabove with reference to [FIG. 4]). Indeed, these steps can be carried out indifferently on a reprogrammable computing machine (a PC computer, a DSP processor or a microcontroller) executing a program comprising a sequence of instructions, or on a dedicated computing machine (for example a set of logic gates like an FPGA or an ASIC, or any other hardware module).

In the case where the electronic device 500 is produced with a reprogrammable computing machine, the corresponding program (i.e. the sequence of instructions) could be stored in a storage medium, removable (such as for example a CD-ROM, a DVD-ROM, a USB key) or not, this storage medium could be read partially or entirely by a computer or a processor.

According to some implementations, the electronic device 500 further implements the inverse Walsh transform step E410c. However, according to the aspect of [FIG. 5], the binary character of the Walsh sequences (i.e. the fact that the sequences in question have two binary values) is leveraged to implement such an inverse Walsh transform in a semi-analog manner. More particularly, the blocks 240 comprise inverse Walsh transform means comprising for example:
a plurality of 1-bit DACs (for example of the buffer type), each DAC being amplitude-controlled by the inverse Walsh sequence corresponding to the sequential component considered for the inverse transform; and
an analog summer in order to sum up the outputs of the different 1-bit DACs together and thus generate an analog quantity (voltage or current) representative of the inverse Walsh transform of the input signal so as to generate the output signal.

Furthermore, the transmitter 200 comprises means for analogue/RF frequency translation, i.e. the quadrature mixer 120, which means are configured to implement step E420. Such a quadrature mixer 120 is, for example, implemented via transistors configured to hash, at the rhythm of the local oscillator signal, the signal to be frequency translated.

Thus, in all aspects, the transmitter 200 comprises means configured to execute all or part of the steps of the generation method of [FIG. 4] (according to any one of the aspects and/or alternative aspects described hereinabove with reference to [FIG. 4]).

What is claimed is:

1. A method for generating a radio signal intended to be transmitted over a first transmission channel, wherein a transmitter carries out:
a frequency translation by implementing a quadrature mixer producing said radio signal from a first intermediate frequency signal and a second intermediate frequency signal, and wherein, for said first transmission channel, the transmitter:
carries out a frequency translation of first baseband signals, producing a first intermediate frequency channel signal; and
generates first phase-shifted channel signal according to the first intermediate frequency channel signal, the first intermediate frequency signal being linearly dependent on the first intermediate frequency channel signal, the second intermediate frequency signal being linearly dependent on the first phase-shifted channel signal,
characterized in that generating the first phase-shifted channel signal comprises:
a Walsh transform step transforming the first intermediate frequency channel signal, producing a first transformed channel signal;
Hilbert filtering, translated to the Walsh domain, of the first transformed channel signal, producing a first filtered, transformed channel signal; and
an inverse Walsh transform step transforming the first filtered, transformed channel signal, producing the first phase-shifted channel signal.

2. The method according to claim 1, wherein said quadrature mixer is fed by two quadrature local oscillator signals, the two local oscillator signals having a radio frequency component, and
wherein said first channel is centered on a frequency equal to the radio frequency plus the intermediate frequency or on a frequency equal to the radio frequency minus the intermediate frequency.

3. The method according to claim 1, wherein the radio signal is also intended to be transmitted over a second transmission channel,
wherein, for said second transmission channel, the transmitter:
carries out a frequency translation of second baseband signals, producing a second intermediate frequency channel signal; and
generates a second phase-shifted channel signal according to the second intermediate frequency channel signal, the first intermediate frequency signal being linearly dependent on a sum of the first intermediate frequency channel signal and of the second intermediate frequency channel signal, the second intermediate frequency signal being linearly dependent on a difference between the first phase-shifted channel signal and the second phase-shifted channel signal, and wherein the generation of the second phase-shifted channel signal comprises:
a Walsh transform step transforming the second intermediate frequency channel signal, producing a second transformed channel signal;
Hilbert filtering, translated to the Walsh domain, of the second transformed channel signal, producing a second filtered, transformed channel signal; and
an inverse Walsh transform step transforming the second filtered, transformed channel signal, producing the second phase-shifted channel signal.

4. The method according to claim 1, wherein the radio signal is also intended to be transmitted over a second transmission channel,
wherein, for said second transmission channel, the transmitter:
carries out a frequency translation of second baseband signals, producing a second intermediate frequency channel signal; and
generates a second phase-shifted channel signal according to the second intermediate frequency channel signal, the first intermediate frequency signal being linearly dependent on a difference between the first intermediate frequency channel signal and the second intermediate frequency channel signal, the second intermediate frequency signal being linearly dependent on a sum of the first phase-shifted channel signal and of the second phase-shifted channel signal, and wherein the generation of the second phase-shifted channel signal comprises:
a Walsh transform step transforming the second intermediate frequency channel signal, producing a second transformed channel signal;
Hilbert filtering, translated to the Walsh domain, of the second transformed channel signal, producing a second filtered, transformed channel signal; and
an inverse Walsh transform step transforming the second filtered, transformed channel signal, producing the second phase-shifted channel signal.

5. The method according to claim 3, wherein said quadrature mixer is fed by two quadrature local oscillator signals, the two local oscillator signals having a radio frequency component, wherein said first channel is centered on a frequency equal to the radio frequency plus the intermediate frequency, and wherein said second channel is centered on a frequency equal to the radio frequency minus the intermediate frequency.

6. The method according to claim 1, wherein Hilbert filtering comprises block digital filtering.

7. The method according to claim 1, wherein said Walsh transform and said inverse Walsh transform are discrete Walsh transforms, the Walsh sequences implemented in said transforms being ordered according to a Hadamard order.

8. A computer program product comprising program code instructions for implementing the method according to claim 1, when said program is executed on a computer.

9. A transmitter for generating a radio signal intended to be transmitted over a first transmission channel, the transmitter comprising:
means for frequency translation by the implementation of a quadrature mixer, producing said radio signal from a first intermediate frequency signal and from a second intermediate frequency signal,
and, for said first transmission channel:
frequency translation means for translating first baseband signals, producing a first intermediate frequency channel signal; and
means for generating a first phase-shifted channel signal according to the first intermediate frequency channel signal,
the first intermediate frequency signal being linearly dependent on the first intermediate frequency channel signal, the second intermediate frequency signal being linearly dependent on the first phase-shifted channel signal, characterized in that the means for generating the first phase-shifted channel signal comprise:
Walsh transform means transforming the first intermediate frequency channel signal, producing a first transformed channel signal;
Hilbert filtering means, translated to the Walsh domain, filtering the first transformed channel signal producing a first filtered, transformed channel signal; and
inverse Walsh transform means transforming the first filtered, transformed channel signal, producing the first phase-shifted channel signal.
